(19) United States
(12) Patent Application Publication
(10) Pub. No.: US 2004/0098491 A1
(43) Pub. Date: May 20, 2004

(54) Accessing presence information

(76) Inventors: Jose Costa-Requena, Helsinki (FI); Mikko Lonnfors, Helsinki (FI); Eva-Maria Leppanen, Tampere (FI); Juha Kalliiokulju, Vesilahti (FI); Anu Honkala, Camberley (GB); Markus Isomaki, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/293,929

(22) Filed: Nov. 14, 2002

(51) Int. Cl. G06F 15/16

(52) U.S. Cl. 709/229

(57) ABSTRACT

A method of accessing presence information includes receiving a summary of the presence information available, and determining desired presence information from the available presence information. In dependence on the determining step, transmitting a request for the selected presence information.

### FIELD OF THE INVENTION

The present invention relates to the provision of presence services, particularly but not exclusively to the provision of presence services in mobile communication systems including an IP Multimedia Subsystem (IMS)

### BACKGROUND OF THE INVENTION

The provision of presence services is set to become an important feature of third generation mobile communication systems. The presence services allow applications and services to be provided to a user of mobile or fixed equipment in dependence on the position or location of the user or equipment.

In mobile communication systems it is important to minimise the traffic over the radio interface. In current proposals for implementing presence services, when a user subscribes to presence services the presence server transmits all possible presence information for the user over the radio interface to the user's terminal. Thus all the presence data that is available is first provided to the user, and after that the user optionally selects the data of interest. This procedure places an unnecessary burden on the radio interface in a wireless environment, as unnecessary data traffic, which is not needed by the user is transmitted over the radio interface. It is also possible that the receiving terminal may not be able to store and handle all the presence data, which is transmitted to it by the presence server.

In current proposals, all of the presence data is transmitted to the user terminal for “learning” purposes, i.e. so that the user can select what information is of interest based on knowledge of what information is available.

It is an object of the present invention to provide an improved method for providing presence services, which addresses one or all of the above-stated problems.

### SUMMARY OF THE INVENTION

According to a first aspect of the present invention, there is provided a method of accessing presence information, comprising: receiving a summary of the presence information available; determining desired presence information from the available presence information; and, in dependence on said determining step, transmitting a request for the selected presence information.

The method may further comprise transmitting a request for presence information, wherein the summary is received responsive to said request; and receiving the selected presence information responsive to the request for selected presence information. The request may be a request for said summary. The step of transmitting a request may include transmitting a subscription message. The subscription message may be a SIP SUBSRIBE message. The summary of presence information may be received in a notification message. The notification message may be a SIP NOTIFY message. The step of transmitting a request for selected presence information may comprise transmitting a subscription message. The subscription message may be a SIP SUBSCRIBE message. The selected presence information may be received in a notification message. The notification message may be a SIP NOTIFY message.

The step of receiving the summary of the presence information available may include receiving the full available presence information and compiling a summary of such presence information. The step of compiling a summary may comprise filtering the available presence information.

The filtering may be dependent upon an authorised access level for a user. The access level may be dependent upon a user subscription. The step of compiling a summary may be dependent upon an authorised access level for a user.

In a further aspect the present invention provides a method of accessing presence information comprising: transmitting a request for a summary of available presence information; receiving a summary of the available presence information; determining desired presence information from the summary of available presence information; selectively transmitting a request for any desired presence information; and responsive thereto receiving the desired presence information.

The transmitted messages may be SIP SUBSCRIBE messages, and the received messages may be SIP NOTIFY messages.

In a still further aspect, there is provided a method of providing presence information, comprising: receiving a request for presence information; and providing a summary of the available presence information. The request may be received from a subscriber, and may comprise a subscription message, and the step of providing a summary includes transmitting a notification message. The subscription message may be a SIP SUBSCRIBE message and the notification message is a SIP NOTIFY message.

The method may further comprise receiving a request for presence information selected from said summary, and providing the selected presence information. The request may be received from a subscriber, and may comprise a subscription message, and the step of providing the selected presence information includes transmitting a notification message. The subscription message may be a SIP SUBSCRIBE message and the notification message may be a SIP NOTIFY message.

The step of providing a summary of the available presence information may include providing an identity of that presence information which is available to a user associated with the request.

The available presence information may be determined by an authorisation access associated with the user. The step of providing a summary may include applying a filter to the available presence information, to thereby provide an identity of the available presence information.

In a still further aspect, the present invention provides a method of providing presence information, comprising: receiving a request for presence information; providing a summary of the available presence information; receiving a request for presence information selected from said summary; and providing the selected presence information. The requests may comprise SIP SUBSCRIBE messages, and the steps of providing include transmitting SIP NOTIFY messages.

The present invention further provides, in another aspect, an application client adapted to access presence information, comprising: input means for receiving a summary of presence information available for the client; means for determining and selecting presence information from said summary; and output means for selectively transmitting a request for any selected presence information.

Said output means may be further adapted to transmit a request for presence information, wherein the summary is received responsive to said request, and wherein said input means is further adapted to receive the selected presence information. The output means may be adapted such that the request for presence information is a request for a summary of presence information. The transmitted request may comprise SIP SUBSCRIBE messages, and the received replies may comprise SIP NOTIFY messages.

The invention further provides an application server adapted to provide a summary of presence information, comprising input means for receiving a request for presence information; control means for compiling a summary of available presence information responsive to said request; and output means for transmitting a summary of the available presence information.

The input means may further receive a request for presence information selected from said summary, the control means being further adapted to provide the presence information selected from said summary, the output means being further adapted to transmit said selected presence information.

The control means may include a filter for compiling a summary of the presence information available.

The requests may include SIP SUBSCRIBE messages and the transmissions may include SIP NOTIFY messages.

In a further aspect of the present invention, there is provided, in a communication system including an application client and an application server, a method of accessing presence information, comprising: transmitting, from said application client, a request for presence information; receiving, at said application server, said request for presence information; compiling, at said application server, a summary of the presence information available for the application client; transmitting, from said application server, said summary; receiving, at said application client, said summary; selecting from said summary, at said application client, any desired presence information; selectively transmitting, from said application client, a request for any selected presence information; receiving, at said application server, said request; compiling, at said applications server, the presence information associated with said request; transmitting, from said application server, said presence information; and receiving, at said application client, the presence information.

Thus the invention enables a subscriber to receive a summary of the presence information that the user can subscribe to. Preferably the subscriber may also request for notification of changes or updates in the summary.

In an embodiment, the terminal which the user is using is provided with a summary of the presence information to enable the terminal to filter the more relevant information for the subscriber rather than provide the whole presence data information to the subscriber.

The invention advantageously minimises the traffic going over the radio interface. In the case of presence services, it is possible for the user terminal (i.e. the watcher) to select only the data (i.e. the presence information) that the user is interested in.

The mechanism according to embodiments of the present invention allows the terminal (the watcher) to subscribe to the presence of any user (presentity) and indicate that the subscriber wants merely to receive a summary of the presence information. The summary of the presence information may include, in various embodiments, names, identifications, or some type of description of available (elements) of presence information.

After receiving the subscription with this mechanism, in embodiments the presence server is able to compose the presence structure including a summary of the presence information. This presence structure may include identification, name, or other description (of presence tuples according to IETF presence structure, presence attributes according to Wireless Village presence structure or any alternative presence data format) of available information that the terminal or watcher is able to subscribe to.

### BRIEF DESCRIPTION OF THE DRAWINGS

The present invention is described herein by way of reference to the accompanying figures in which:

FIG. 1 illustrates a network scenario in which a preferred embodiment of the present invention may be implemented;

FIG. 2 illustrates the method steps in retrieving presence information in a first part of an embodiment of the present invention;

FIG. 3 illustrates the method steps performed in retrieving presence information in a second part of an embodiment of the present invention;

FIG. 4 shows a presence server adapted to implement the described embodiment of the present invention; and

FIG. 5 illustrates an example implementation of user equipment for implementing an embodiment of the present invention.

### DESCRIPTION OF PREFERRED EMBODIMENTS

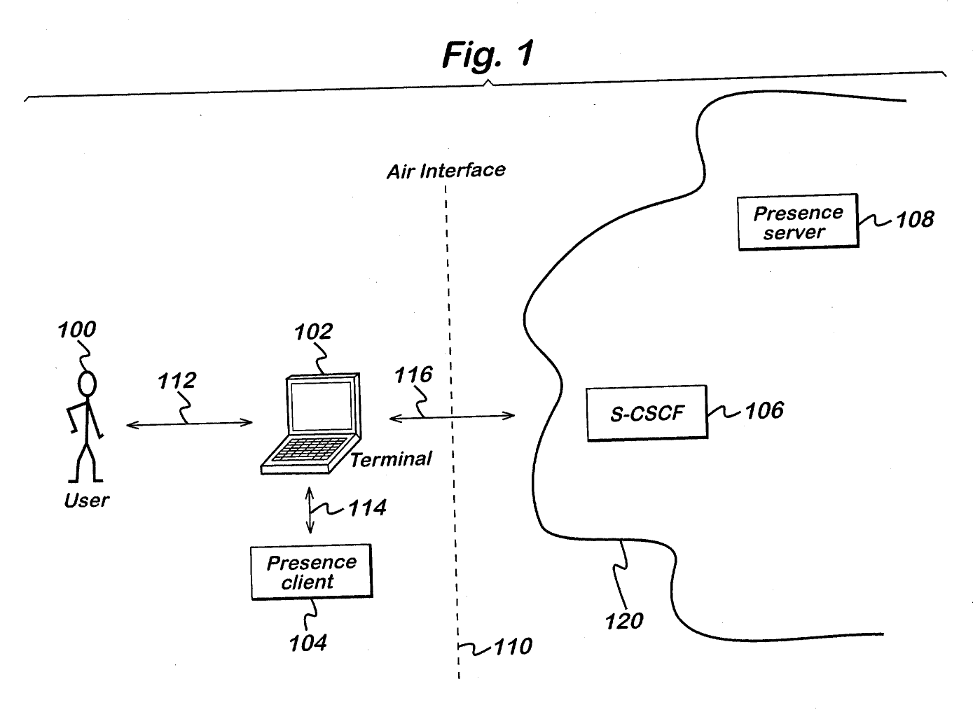

The present invention is described herein with reference to particular exemplary embodiments. The skilled person will appreciate that the invention is not limited in its scope to the embodiments described herein. In particular the present invention is described herein with reference to an implementation in a wireless communication system, where the user is associated with a mobile terminal. The invention is not limited to applications in mobile communication networks, or to the user of mobile terminals. The invention may equally be used in fixed line communication networks and in fixed terminals. Referring to FIG. 1, there is illustrated the main elements of a mobile communication system required for the purposes of describing preferred embodiments of the present invention. Only the elements are shown which are required for the purposes of illustrating the embodiments of the present invention. The general structure of communication networks implementing presence services is known in the art. One skilled in the art will appreciate the essential elements required in order to implement known presence services.

In particular FIG. 1 describes an example implementation of a network arrangement for providing presence services. It should be noted that many aspects of presence services, including the use of terminology, are not yet standardised. The use of terminology in the following description should be considered with this in mind; the important aspect of the following description being an understanding of the functional aspects of the elements described.

In presence services, a user can access presence services in a different number of ways. A first type of user is known as a presentity. The presentity is an owner of presence information. The presence information owned by the presentity is stored, for example on a presence server, and distributed to other users. A second type of user is known as a watcher. A watcher receives presence information from a presence service, i.e. presence information associated with a presentity. Subscriber is a term which may also be used generally to refer to a user that is subscribing to the presence information of a presentity

The present invention is concerned with accessing presence information, and therefore from the perspective of describing the present invention the user should be considered to be a user accessing presence information rather than a user creating presence information. As such, in the following description, the user is referred to as a watcher, consistent with terminology currently preferred in the art.

In FIG. 1, a user acting as a watcher and identified by reference numeral 102, accesses presence services. The bidirectional arrow 112 represents the user 100 interface with the terminal 102. The user inputs information at the terminal 102 by way of a keyboard (for example), and receives information from the terminal 102 by way of the terminal's display (for example). The terminal 102 may be any number of types of devices, such as a mobile telephone, a personal data assistant, a laptop computer, or a desktop computer.

A presence client generally illustrated by reference numeral 104 in FIG. 1 represents an application running on the terminal 102. The bi-directional line 114 represents the interaction of the presence client 104 with the terminal 102. The presence client 104 is software running on the terminal 102, which enables the user 100 to access presence services.

Thus, the user (watcher) 100 interacts with the presence client 104 in the terminal 102 in order to access presence information. It should be noted that in practice the combination of the user 100, the presence client 104 and the terminal 102 may be considered to be the watcher. Furthermore, the presence client 104 is preferably software running on the terminal 102, which the terminal may have downloaded, and the terminal 102 and presence client 104 may be considered to be a single entity.

It will be appreciated, from the above description, that at other times the user 100 may be acting as a presentity.

In the embodiment of FIG. 1, the terminal 102 interfaces with a mobile communication network generally illustrated by reference numeral 120. The terminal interacts with the mobile communications network 120 over the air interface, generally represented by the dashed line 110. The bi-directional arrow 116 represents communications over the air interface 110 between the terminal 102 and the mobile communications network 120.

For the purposes of understanding the present invention, the mobile communications network 120 is shown to include a serving call state control function (S-CSCF) 106, and a presence server 108. As stated above, the structure and implementation of such a network is well-known, and only the minimum elements required to describe an embodiment of the present invention are shown in FIG. 1. It should also be noted that such a network implementation is illustrated for the purposes of example only. In alternative arrangements the elements shown in FIG. 1, such as the S-CSCF, may not be required. In practice in the embodiment the S-CSCF 106 forms part of the mobile communication network 120, whereas the presence server 108 may be provided in an external Internet protocol (IP) network. As it is known in the art, the S-CSCF 106 supports a call made to the mobile network by the terminal 102.

The mobile communications network 120 may, for example be a UMTS network or other network supporting presence services. It should also be noted that the present invention is not limited in its applicability to the provision of presence services over a radio interface. The presence services may be provided over a fixed line communications network.

The presence server 108 stores or host presence information associated with various presentities. Access to presence information may be public or restricted. Restrictions may be based on level of subscription, or authorisation identities, e.g. in the form of an access control list provided by the presentity.

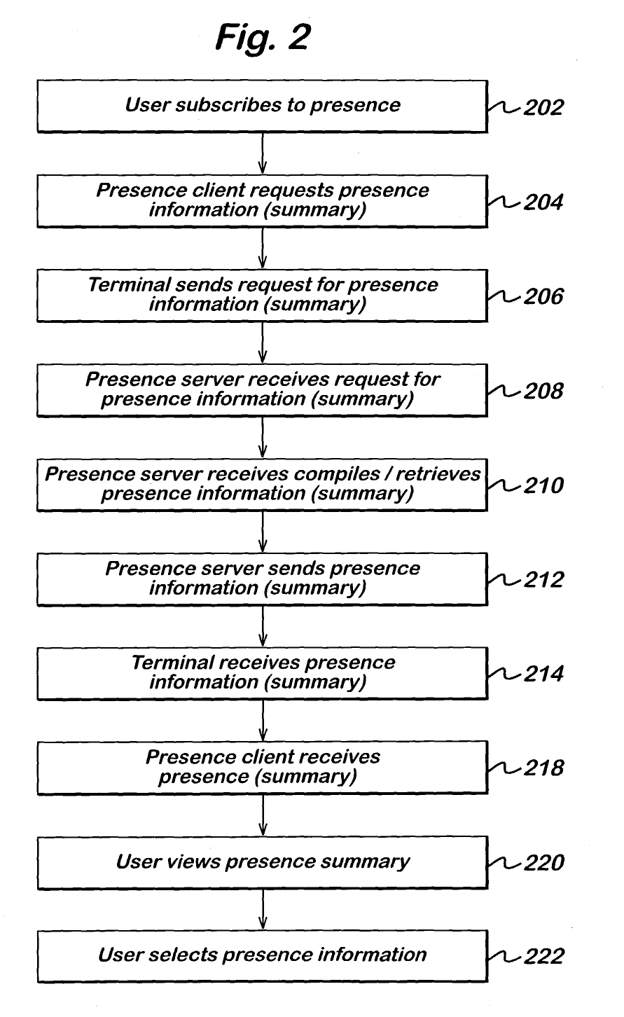

Referring to FIG. 2, there is illustrated a flow chart for describing a first embodiment of the present invention.

In a step 202, a user subscribes to access presence information by using the terminal 102 running the presence client 104, and indicates that he/she wishes to obtain presence information associated with another user (presentity).

In a step 204 the presence client 104 requests the identified presence information, specifically a summary of the presence information. As such, and as it is further described herein below, the terminal 102 and the presence client 104 is adapted to transmit a request for presence information which includes an identification that a summary of presence information is required.

In a step 206 the terminal 102 running the presence client application software transmits a request for the presence information summary toward the presence server 108.

The request for the presence information summary is carried through the radio interface and through the mobile communications network to the presence server 108 in accordance with techniques known in the art and which are not relevant to the present invention. In a step 208, the presence server 108 receives the request for the summary of presence information.

In a step 210 the presence server compiles the appropriate presence information, or retrieves the presence information from the memory store. All subscribers are associated with a level of access for the presence information of a presentity. The level of access may be determined by the type of subscription, where a more expensive subscription provides greater presence information. The level of access may also be subscriber specific, with only certain subscribers being able to access certain information. The presentity (i.e. the owner of the presence information) can set an access policy for its own presence information. This policy may indicate that subscriber A can access all presence information (say all 35 tuples of presence information), whilst subscriber B can only access part of the presence information (say only tuples 1,3, and 5 of the presence information). A tuple is a term well-known in the art, and is a data structure that contains attributes for defining presence information. A presence document is composed of zero to many tuples. A tuple may contain attributes such as “status”, “contact” etc. Authorisation may also be based on other available information included in the presence document.

All though for the purposes of describing an embodiment of the invention reference is made to presence services utilising tuples, the invention is in no way limited to the use of tuples. Not all presence services utilise a tuple-based structure. For example, a Wireless Village based system has all information as individual attributes.

Every request for presence information, as is known in the art, is required to identify the subscriber (i.e. user) making the request and to identify the presence information of interest, i.e. the presentity associated with that presence information. Based on the identity of the subscriber, the presence server 108 can identify the presence information, presence attributes or tuples, accessible to that subscriber for the identified presentity. As such, the presence server can retrieve the authorised presence information for that subscriber.

In accordance with the present invention the presence server 108 identifies, in the presence information request received from the terminal 102, that the request is for a summary of the presence information. The indication that the request is for a summary may be made in a number of ways, which are implementation dependent, and which are discussed in further detail herein below.

On detection of a request for a summary of presence information, the presence server is adapted to process such request to compile a summary of the presence information. The presence server thus compiles, based on the information authorised for that subscriber, a summary of that information. The format of that summary is, as discussed in further detail herein below, implementation dependent. However the summary may, for example, be a summary of the tuples available or a summary of all the attributes available (most of them without values).

In a step 212, the presence server 108 sends the presence information summary back towards the terminal 102. The terminal 102 then forwards the presence information summary thus received to the presence client 104 in a step 216. The presence client 104 receives the presence information summary in a step 218, and displays it on a display of the user terminal 102. In a step 220 the user 100 then views the presence summary on the terminal 102 display.

In accordance with this embodiment of the present invention, the terminal 102 (in conjunction with the presence client 104) is adapted to display the summary of the presence information in such a way that the subscriber can select the presence information of interest. Thus the summary of the information available may be displayed on a display, and the subscriber may use the keypad or display to select the information of interest. The selection of the presence information of interest from the summary is represented by step 222.

Preferably the summary document may contain information as to how to select the presence information of interest. That is, the summary may contain, for example, a short description of all the tuples that are available. The summary also preferably contains, for example, corresponding tuple identifications so that a watcher can make the next subscribe, and identify the information pieces of interest. It should also be noted that tuple ID is not the only possibility for identification. Others could be, for example, application ID, attribute name, contact address, communication means, etc. or some combination of these.

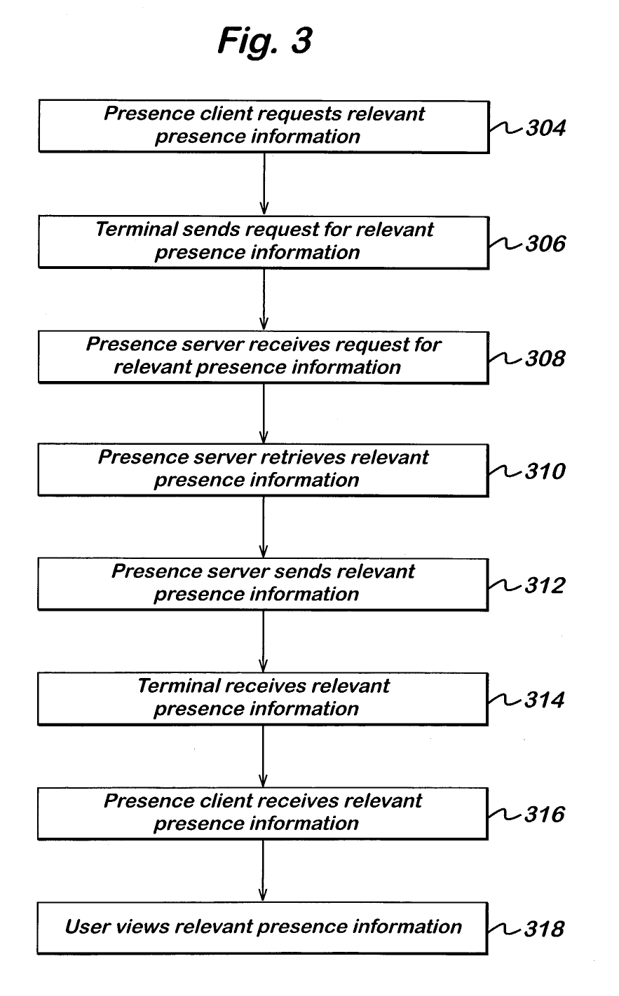

Thus, as described hereinabove with reference to FIG. 2, there is provided in accordance with this embodiment of the invention a subscribe request to the presence server from the subscriber, followed by a notify from the presence server to the subscriber. In accordance with this embodiment of the present invention, there is further provided a second subscribe-notify procedure, as shown in the flow chart of FIG. 3.

The presence client processes the selections made by the user 100 in step 222, and requests the relevant presence information in the step 304. The terminal 102 sends the request for the relevant presence information toward the presence server 108 in step 306.

In a step 308 the presence server 108 receives the request for the relevant presence information. The presence server retrieves the relevant presence information in a step 310. That is the presence server 108 retrieves the specific information requested by the subscriber or user 100. Thus the presence server retrieves the full presence information for those parts of the presence information requested by the subscriber, based on the selection from the presence service summary. In a specific embodiment, the presence server 108 receives the tuples identifying the information requested by, the subscriber, and retrieves the full information associated with those tuples.

After the full information for the selected parts of the presence information is retrieved, in a step 312 the presence server 108 sends the relevant presence information toward the terminal 102.

In a step 314 the terminal 102 receives the relevant presence information, and forwards it to the presence client, which receives the relevant presence information in a step 316. The presence client displays the relevant presence information on the display of the user terminal 102, or makes available the relevant presence information for display on the user terminal 102. Thereafter the user may view the relevant presence information in a step 318.

The presence information may also be consumed by the client/application.

Thus, in accordance with the present invention as described in the first embodiment, the whole presence information associated with a request for presence information is not transmitted across the air interface from the presence server 108 to the terminal 102. Only that information which is required by the user or subscriber is transmitted across the air interface from the presence server 108 to the terminal 102.

The invention does require, in the described embodiment, two subscribe-notify procedures. However this entails a much more efficient use of the resources in the network than a single subscribe-notify in which the whole presence information is transferred to the terminal 102.

Whilst the specific advantage of not transferring the whole presence information can be readily appreciated in the context of a mobile communication system utilising an air interface, the invention has similar advantages in any application, since it reduces the volume of information to be transmitted on a communication link.

It is preferable for the present invention to work alongside existing techniques. That is, it is preferable for the presence server to return full presence information if the terminal requesting the presence information does not support the use of presence information summaries. Preferably, therefore, the subscribe request message transmitted to the presence server for requesting presence information includes an indication of whether or not a summary of presence information is requested. In this way the presence server can return summary information responsive to a summary request, and full information if a summary request is not detected.

The present invention is not limited to a specific way for indicating a request for summary of presence information. The request may be made by adapting an existing header or providing a new header in the subscribe messages sent to the presence server. Alternatively the message may be adapted to include a flag indicating a summary request.

In an alternative, the request may be made using a ‘normal’ subscribe message which contains a filter, which filter is then applied at the presence server to filter out all attribute values from the presence notification. In a further alternative there may be provided a preset filter in the presence server which filters out any additional information, and results in a presence summary being returned to the watcher.

The presence server is further preferably adapted in order to provide an appropriate summary of the presence information to the subscriber. Again, the provision of the summary may be implementation dependent and the present invention is not limited to a specific technique. Three possible techniques are considered.

In a first technique, the presence server may generate a summary tuple that includes a short information summary of all the tuples that are allowed for a particular watcher. This may require for multiple summaries to be created, corresponding to the number of levels of access that there are for particular presence information.

In a second technique, the presence server may retrieve all the presence information authorised for that subscriber for the information associated with that presentity. Thereafter the presence server may create a summary by filtering out various attributes from each tuple, thus resulting in a list of tuple identifiers and a short description of the tuple contents.

In a third technique, the second technique is adapted to further include a list of attributes (e.g. attribute names) inside the delivered tuple information. In alternative implementations an alternative to tuples information may be delivered, as appropriate for the application.

The presence server is preferably adapted to filter the presence information based on a filter criteria received in the following (i.e. second) subscribe message sent from the terminal. That filter criterion contains logic to indicate the specific presence information that is requested by the subscriber. This filter may then be applied to filter the presence information for the subscriber to allow only the requested information to be transmitted to the terminal. This filter criteria is preferably set by the subscriber, in dependence upon the information which the subscriber has indicated to be of interest. Thus the filter is preferably set by the information sent to the presence server on the second subscribe message. The presence server then filters the presence information to send only that information indicated to be desired back to the terminal of the subscriber.

Thus, in a first subscriber message the subscriber indicates to the presence server that it wishes to receive a summary of the available presence information, and responsive thereto the presence server returns such summary. This may be considered to be the application of a first filter by the presence server, filtering the presence information to include only a summary of that which is available.

In a second subscriber message the subscriber identified that presence information of interest. The presence server then returns the full details of that specific presence information to the subscriber terminal. This may be considered to be the application of a second filter by the presence server, filtering the presence information to include only that which is specifically required.

It is possible that at least one of the filtering operations, for example the first filtering operation, could be implemented in the terminal itself rather than in the presence server. However such an arrangement would not be as advantageous as full implementation of the filters in the presence server, since implementing any aspect of the filtering in the terminal requires transmission of the full presence information over the air interface.

However in one particular envisaged embodiment, responsive to a first subscribe request the full presence information is transmitted to the terminal, and the terminal performs a first filtering operation to display a summary of the presence information.

Thereafter, the selected information is communicated to the presence server in a second subscribe message. The presence server then applies the second filtering operation to return only the desired presence information to the terminal, thereby minimising traffic on the air interface. Alternatively, the full presence information may be returned to the terminal, and the second filter applied in the terminal. This latter option for the location of the second filtering does not, however, offer significant advantages over the prior art.

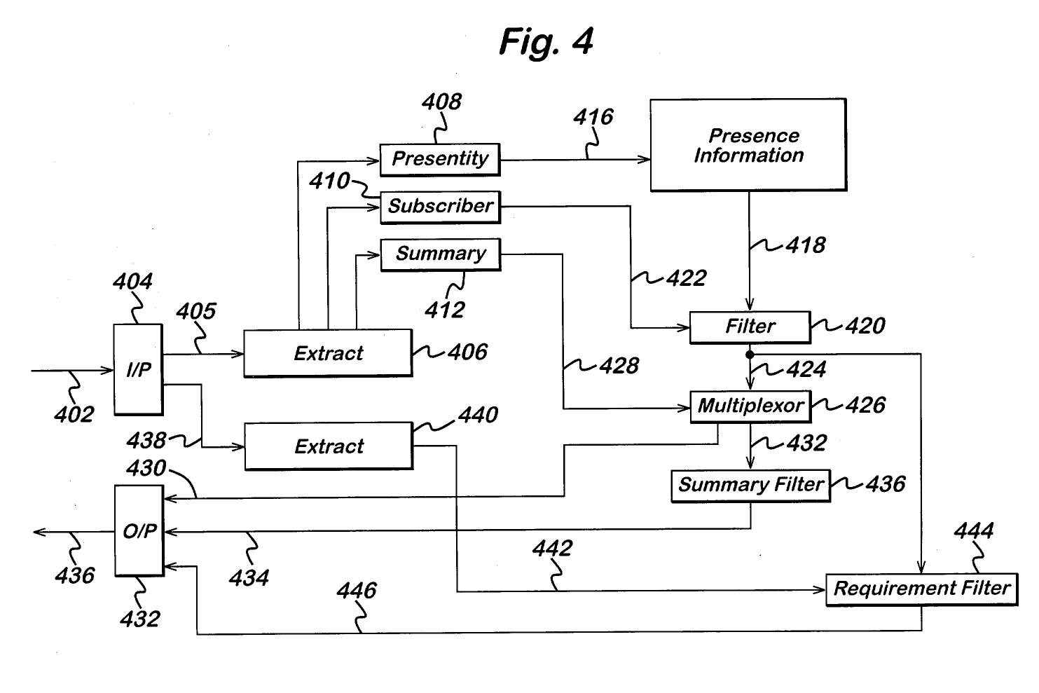

An example implementation of a presence server for implementing the preferred embodiment of the invention described hereinabove will now be described with reference to FIG. 4. FIG. 4 illustrates a possible implementation of the presence server, but the invention is not limited to such an implementation. Further, FIG. 4 is not representative of a full implementation for a presence server. Such implementation will be familiar to one skilled in the art.

A subscribe request, requesting presence information for a subscriber, is received on a signal line 402, at an input block 404. The received signal is forwarded on line 405 to an extraction block 406 which extracts information from the received signal. The extraction block extracts: the presentity identifier, identifying the presence information required, and stores it in a presentity store 408; the subscriber identity identifying the subscriber requesting the presence information, and stores it in a subscriber store 410; and the summary identity, indicating whether the request is for a summary of the presence information or the full information, and stores it in a summary store 412. The summary store 412 may simply be a flag, and the extraction block 406 may extract the information identifying whether the request is for a summary or not from a header, for example, of the incoming message.

The presence server, using the presentity identity in store 408 output on line 416, retrieves from a presence information store 414 the presence information associated with that presentity. The presence information for the presentity is output on a line 418 to a subscriber filter 420. The subscriber filter 420 also receives as an input the subscriber identity in the store 410 on an output line 422 thereof. In this way the subscriber filter applies to the presence information for a presentity any filtering associated with the level of subscriber, such that the output of the filter 420 on line 424 corresponds to the presence information available for the subscriber to access. This retrieval of the presence invention is in line with conventional, known procedures. The filter 420 does not apply either of the filtering steps discussed hereinabove with reference to a preferred embodiment of the present invention.

The output of the subscriber filter 424 is provided on line 424 as an input to a multiplexer block 426, which also receives as a further input on line 428 the summary value stored in the store 412. If the summary value indicates that the full presence information, and not a summary, is required then the output of the filter 420 on line 424 is provided on line 430 to an output means 432, and the presence information returned to the subscriber terminal.

However, if the summary value indicates that the presence information summary is required, the output of the filter 420 on line 424 is output on line 432 of the multiplexer 426, for further processing in accordance with the principles of the present invention.

The output of the multiplexer 426 on line 432 forms an input to a summary filter 436, which performs the first filtering step as described hereinabove with reference to a preferred embodiment. The summary filter filters the presence information to provide a summary of the presence information on line 434. The summary is prepared in accordance with the implementation specifics, as discussed hereinabove. The summary of the presence information on line 434 is then provided to the output block 432 for transmission to the subscriber's terminal as represented by a message on line 434.

The filter 436 thus performs the first filtering operation described hereinabove with reference to an embodiment of the invention.

Thereafter, a further subscribe request is received on the input line 402 of the input block 404. The further subscribe request, being a request including the confirmation of which presence information is required by the subscriber, is provided from the input block 404 on a line 438, to an extraction block 440. The extraction block extracts the identities of the presence information required by the subscriber.

The output of the extraction block 440 forms a control input on line 442 to a requirement filter 444, which receives as its main input the subscriber filtered presence information on line 444. The requirement filter applies the information relating to the required presence information on line 442 to the presence available presence information on line 424, such that the full required presence information is provided on the output on line 446.

The filter 444 thus performs the second filtering step described hereinabove with reference to a preferred embodiment.

The required presence information on line 446 is provided as an input to the output block 432, which transmits the information to the subscriber,terminal as represented by line 436.

The operation of the elements of the presence server illustrated are controlled under the control of a control means which is not shown or described, but the operation of which will be apparent to one skilled in the art.

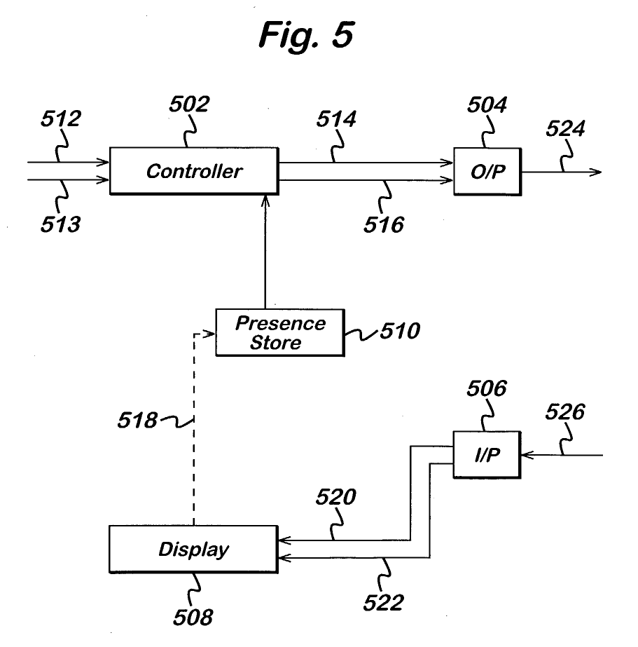

An example implementation of a user equipment for implementing the preferred embodiment of the invention described hereinabove will now be described with reference to FIG. 5. FIG. 5 illustrates a possible implementation of the user equipment, but the invention is not limited to such an implementation. Further, FIG. 5 is not representative of a full implementation of a user equipment. Such implementation will be familiar to one skilled in the art.

Referring to FIG. 5, the exemplary user equipment, such as a mobile telephone handset, is provided with a controller 502. The controller receives a signal on line 512 responsive to a user selecting a request for presence information using the display/keypad of the user equipment. The user equipment is preferably adapted to always request a summary of presence information. As such, the controller forwards a request for a presence information summary, being a subscribe message, on single line 514 to an output block 504. The output block transmits the subscribe message to the presence server, as represented by output line 524.

The user equipment receives, from the presence server, a notify response message, including a summary of the presence information, on input line 526 at input block 506. The received notify message, including the presence information summary, is forwarded on line 520 and displayed on a display of the user equipment, as represented by block 508.

Thereafter a user of the user equipment may use the keypad of the user equipment to select the desired presence information from the display, the selected presence information identities being transferred and stored in a presence information store 510, as represented by dashed line 518.

Once the selection is complete, the controller 502 receives a further input on line 513, and responsive thereto initiates a further subscribe message on line 513. The further subscribe message takes the presence information identifiers from the presence store 510. The further subscriber message is then transmitted to the presence server on line 524 by the output means 504.

The user equipment receives a further notify message on line 526 at input block 506, being the notify message containing the full presence information for the selected presence identities. This information is transferred and displayed on the display 508 via lines 522. The information may be stored in a memory of the user equipment.

The various elements of the user equipment are preferably operated under the control of the controller 502.

Various modifications to the described embodiments will be apparent to one skilled in the art. The request for a summary transmitted from user equipment may have a rigid format, or may be variable. For example, the summary may request one or all of tuple names, identifiers, or some other type of description of available information. The presence server may then be responsive to provide the information requested or a default set of information.

The presence server may allocate a specific tuple which includes only a summary of the information of other tuples, for example the identities of such tuples, to be sent as the summary. However, more than one such tuple is likely to be needed for presence information associated with a given presentity, as different subscribers (watchers) may have different access rights. Different access rights dictate that the summary of information is different according to the access authorisation. As an alternative, the presence server may dynamically create an information package based on a request and the allowed information. The presence server may further be adapted to create tuple structures such that simple tuple filtering may be used for obtaining the summary, for example each tuple having a tuple identifier and summary. Responsive to the first subscribe message the subscriber can set the filter at the presence server to only let through the tuple identifer or some other identifiers and description field. Responsive to the second subscriber message the filter can be modified to let through only the information of interest.

The present invention has been described herein by way of reference to particular, non-limiting examples. One skilled in the art will appreciate that modifications and variations are possible to the embodiments described wherein. The scope of protection is defined by the appended claims.

We claim:

1. A method of accessing presence information, comprising:
receiving a summary of the presence information available;
determining desired presence information from the available presence information; and
in dependence on said determining step, transmitting a request for the selected presence information.

2. A method according to claim 1, further comprising:
transmitting a request for presence information, wherein the summary is received responsive to said request; and
receiving the selected presence information responsive to the request for selected presence information.

3. A method according to claim 2, wherein the request is a request for said summary.

4. A method according to claim 2, wherein the step of transmitting a request includes transmitting a subscription message.

5. A method according to claim 4, wherein the subscription message is a SIP SUBSCRIBE message.

6. A method according to claim 4, wherein the summary of presence information is received in a notification message.

7. A method according to claim 6, wherein the notification message is a SIP NOTIFY message.

8. A method according to claim 1, wherein the step of transmitting a request for selected presence information comprises transmitting a subscription message.

9. A method according to claim 8, wherein the subscription message is a SIP SUBSCRIBE message.

10. A method according to claim 2, wherein:
the step of transmitting a request for selected presence information comprises transmitting a subscription message, the subscription message is a SIP SUBSCRIBE message, and wherein the selected presence information is received in a notification message.

11. A method according to claim 10, wherein the notification message is a SIP NOTIFY message.

12. A method according to claim 1, wherein the step of receiving the summary of the presence information available includes receiving the full available presence information and compiling a summary of such presence information.

13. A method according to claim 1, wherein the step of compiling a summary comprises filtering the available presence information.

14. A method according to claim 13, wherein the filtering is dependent upon an authorized access level for a user.

15. A method according to claim 14, wherein the access level is dependent upon a user subscription.

16. A method according to claim 1, wherein the step of compiling a summary is dependent upon an authorized access level for a user.

17. A method of accessing presence information, said method comprising:
transmitting a request for a summary of available presence information;
receiving a summary of the available presence information;
determining desired presence information from the summary of available presence information;
selectively transmitting a request for any desired presence information; and
receiving the desired presence information responsive thereto.

18. A method according to claim 17, wherein the transmitted messages are SIP SUBSCRIBE messages, and the received messages are SIP NOTIFY messages.

19. A method of providing presence information, said method comprising:
receiving a request for presence information; and
providing a summary of the available presence information.

20. A method according to claim 19, wherein the request is received from a subscriber, and comprises a subscription message, and the step of providing a summary includes transmitting a notification message.

21. A method according to claim 20, wherein the subscription message is a SIP SUBSCRIBE message and the notification message is a SIP NOTIFY message.

22. A method according to claim 19, further comprising receiving a request for presence information selected from said summary, and providing the selected presence information.

23. A method according to claim 22, wherein the request is received form a subscriber, and comprises a subscription message, and the step of providing the selected presence information includes transmitting a notification message.

24. A method according to claim 23, wherein the subscription message is a SIP SUBSCRIBE message and the notification message is a SIP NOTIFY message.

25. A method according to claim 19, wherein the step of providing a summary of the available presence information includes providing an identity of that presence information which is available to a user associated with the request.

26. A method according to claim 25, wherein the available presence information is determined by an authorization access associated with the user.

27. A method according to claim 25, wherein the step of providing a summary includes applying a filter to the available presence information, to thereby provide an identify of the available presence information.

28. A method of providing presence information, said method comprising:
receiving a request for presence information;
providing a summary of the available presence information;
receiving a request for presence information selected from said summary; and
providing the selected presence information.

29. A method according to claim 28, wherein the requests comprise SIP SUBSCRIBE messages, and the steps of providing include transmitting SIP NOTIFY messages.

30. An application client for accessing presence information, said application client comprising:
input means for receiving a summary of presence information available for the client;
means for determining and selecting presence information from said summary; and
output means for selectively transmitting a request for any selected presence information.

31. An application client according to claim 30, wherein said output means is further adapted to transmit a request for presence information, wherein the summary is received responsive to said request, and wherein said input means is further adapted to receive the selected presence information.

32. An application client according to claim 31, wherein the output means is adapted such that the request for presence information is a request for a summary of presence information.

33. An application client according to claim 31, wherein the transmitted requests comprise SIP SUBSCRIBE messages, and the received replies comprise SIP NOTIFY messages.

34. An application server adapted to provide a summary of presence information, said server comprising:
input means for receiving a request for presence information;
control means for compiling a summary of available presence information responsive to said request; and
output means for transmitting a summary of the available presence information.

35. An application server according to claim 33, wherein the input means further receives a request for presence information selected form said summary, the control means being further adapted to provide the presence information selected from said summary, the output means being further adapted to transmit said selected presence information.

36. An application server according to claim 33, wherein the control means includes a filter for compiling a summary of the presence information available.

37. An application server according to claim 34, wherein the requests include SIP SUBSCRIBE messages and the transmissions include SIP NOTIFY messages.

38. In a communication system including an application client and an application server, a method of accessing presence information, said method comprising:
transmitting, from said application client, a request for presence information;
receiving, at said application server, said request for presence information;
compiling at said application server, a summary of the presence information available for the application client;
transmitting, from said application server, said summary;
receiving, at said application client, said summary;
selecting from said summary, at said application client, any desired presence information;
selectively transmitting, from said application client, a request for any selected presence information;
receiving, at said application server, said request;
compiling, at said applications server, the presence information associated with said request;
transmitting, from said application server, said presence information; and
receiving, at said application client, the presence information.
